(19) United States
(12) Patent Application Publication
(10) Pub. No.: US 2026/0363235 A1
(43) Pub. Date: Nov. 19, 2026

(54) ADJUVANT AND ACTIVE INGREDIENT FOR PHYTOSANITARY FORMULATIONS AND PHYTOSANITARY FORMULATIONS

(71) Applicant: TOTALENERGIES ONETECH, Courbevoie (FR)

(72) Inventors: Diego ROMERO, Solaize (FR); Benjamin SWOBODA, Solaize (FR)

(73) Assignee: TOTALENERGIES ONETECH, Courbevoie (FR)

(21) Appl. No.: 19/142,560

(22) PCT Filed: Dec. 21, 2023
(86) PCT No.: PCT/EP2023/087246

§ 371 Date: Jun. 23, 2025

(30) Foreign Application Priority Data
Dec. 23, 2022 (FR) FR2214477

(51) Int. Cl. A01N 25/04; A01N 25/30; A01N 27/00; A01N 47/36; A01P 3/00; A01P 7/02; A01P 13/00

(52) U.S. Cl. CPC A01N 25/04; A01N 25/30; A01N 27/00; A01N 47/36; A01P 3/00; A01P 7/02; A01P 13/00

(57) ABSTRACT

The invention relates to the use of a hydrocarbon fluid as an adjuvant and/or as an active ingredient in a phytosanitary formulation comprising one or more surfactants, said hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C.

### TECHNICAL FIELD OF THE INVENTION

The invention relates to a bio-sourced adjuvant for phytosanitary formulations as well as a bio-sourced active ingredient for phytosanitary formulations. The invention also concerns a phytosanitary formulation comprising said bio-sourced adjuvant or said bio-sourced active ingredient. The invention also concerns the use of this phytosanitary formulation as a herbicide and/or an insecticide and/or an acaricide and/or a fungicide and/or a biostimulant.

### STATE OF THE ART

It is known to use phytosanitary formulations to ensure crop protection, said formulations able to serve as fungicides or insecticides but also as fertilizers. Said phytosanitary formulations are generally sprayed on crops in the form of a solution in water or water/oil or oil/water emulsions, in the presence of surfactant additives.

For a long time, petroleum-based oils emulsified in water have been sprayed on crops for insecticidal purposes. Properly prepared, such oils can affect fungi and parasites while having no negative effect on phytosanitary development. Among conventional refined oils, obtained from crude oil and/or distillates from refining, by solvent extraction or by hydrodeoxygenation of base oils, the industrialist will choose those that are the least toxic but most effective, e.g. against insects and/or fungal attacks. It has been found that the more paraffinic the oil produced, i.e. comprising, linear or branched, saturated carbon chain compounds, the more effective said oil is against insects and the less phytotoxic said oil is for plants.

To optimize field applications, end users need certain supplements to improve the performance of active materials at the time of application. Said complements are adjuvants. The functions of said adjuvants are to reduce drift, to improve the quality of the mixture, to increase resistance to leaching, to improve penetration into tissues among others, and to allow for the integration of an economic and environmental component by reducing pesticide consumption.

Documents FR2984690 and FR2953369 disclose the use of a petroleum-based oil as a phytosanitary active ingredient.

Paraffinic oils of the state of the art are petroleum-based oils not easily biodegradable.

The present invention aims to provide an easily biodegradable bio-sourced hydrocarbon fluid, as an adjuvant or active ingredient for phytosanitary formulation.

### SUMMARY OF THE INVENTION

The invention relates to the use of a hydrocarbon fluid as an adjuvant and/or as an active ingredient in a phytosanitary formulation comprising one or more surfactants, said hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C.

According to one embodiment, the phytosanitary formulation comprises:
from 0.5 to 20% by weight, preferably from 1 to 15% by weight, more preferably from 2 to 10% by weight, of one or more surfactants,
from 80 to 99.5% by weight, preferably from 85 to 99% by weight, more preferably from 90 to 98% by weight, of hydrocarbon fluid,
relative to the total dry weight of the phytosanitary formulation.

Preferably, the surfactants are chosen from alkoxylated acids, sorbitan esters, alkoxylated alcohols, and mixtures thereof.

According to one embodiment, the hydrocarbon fluid comprises relative to the total weight of the hydrocarbon fluid:
at least 85% by weight of isoparaffins, preferably at least 90% by weight, more preferably at least 95% by weight, and/or
at most 20% by weight of normal paraffins, preferably at most 10% by weight, more preferably at most 5% by weight, and/or
at most 1% by weight of naphthenes, and/or
less than 50 ppm by weight of aromatics.

According to one embodiment, the hydrocarbon fluid has:
a flash point greater than or equal to 110 °C, preferably greater than or equal to 120 °C, or even greater than or equal to 130 °C according to the ASTM D93 standard, and/or
a kinematic viscosity at 40 °C less than or equal to 5 cSt, preferably less than or equal to 4 cSt, and/or
a biogenic carbon content of at least 90% by weight, preferably at least 95% by weight, more preferably at least 97% by weight, relative to the total weight of carbon atoms of the hydrocarbon fluid,
a difference between the final boiling point and the initial boiling point ranging from 10 °C to 80 °C, preferably from 20 °C to 50 °C.

According to one embodiment, the hydrocarbon fluid comprises, relative to the total weight of the hydrocarbon fluid:
from 5 to 15% by weight of C15 isoparaffins, from 30 to 60% by weight of C16 isoparaffins, from 10 to 30% by weight of C17 isoparaffins, and from 10 to 30% by weight of C18 isoparaffins, or
from 10 to 30% by weight of C17 isoparaffins and from 60 to 90% by weight of C18 isoparaffins.

According to one embodiment, the phytosanitary formulation is in the form of an emulsifiable concentrate or an emulsion.

According to one embodiment, the hydrocarbon fluid is used as an adjuvant in a phytosanitary formulation, said phytosanitary formulation further comprising at least one active ingredient chosen from herbicides, insecticides, acaricides, fungicides, and biostimulants, preferably from herbicides.

According to one embodiment, the hydrocarbon fluid is used as an active ingredient in a phytosanitary formulation, said active ingredient being chosen from insecticides, acaricides, fungicides, and biostimulants, preferably said phytosanitary formulation being free of active ingredient chosen from herbicides, insecticides, acaricides, fungicides, biostimulants, different from the hydrocarbon fluid, more preferably said phytosanitary formulation being free of phytosanitary active ingredient different from the hydrocarbon fluid.

According to one embodiment, the phytosanitary formulation is used for the preventive and/or curative treatment of crop diseases.

The invention also concerns a phytosanitary formulation comprising:
a hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C, and
one or more surfactants,
   characterized in that:
a) the formulation further comprises an active ingredient chosen from herbicides, insecticides, acaricides, fungicides, and biostimulants, and/or
b) the weight ratio between the hydrocarbon fluid and the surfactants ranges from 18 to 40.

According to one embodiment of the phytosanitary formulation according to the invention:
the hydrocarbon fluid has one or more of the following features:
   the hydrocarbon fluid comprises relative to the total weight of the hydrocarbon fluid:
      at least 85% by weight of isoparaffins, preferably at least 90% by weight, more preferably at least 95% by weight, and/or
      at most 20% by weight of normal paraffins, preferably at most 10% by weight, more preferably at most 5% by weight, and/or
      at most 1% by weight of naphthenes, and/or
      less than 50 ppm by weight of aromatics;
   the hydrocarbon fluid has:
      a flash point greater than or equal to 110 °C, preferably greater than or equal to 120 °C, or even greater than or equal to 130 °C according to the ASTM D93 standard, and/or
      a kinematic viscosity at 40 °C less than or equal to 5 cSt, preferably less than or equal to 4 cSt, and/or
      a biogenic carbon content of at least 90% by weight, preferably at least 95% by weight, more preferably at least 97% by weight, relative to the total weight of carbon atoms of the hydrocarbon fluid,
      a difference between the final boiling point and the initial boiling point ranging from 10 °C to 80 °C, preferably from 20 °C to 50 °C;
the hydrocarbon fluid comprises, relative to the total weight of the hydrocarbon fluid:
   from 5 to 15% by weight of C15 isoparaffins, from 30 to 60% by weight of C16 isoparaffins, from 10 to 30% by weight of C17 isoparaffins, and from 10 to 30% by weight of C18 isoparaffins, or
   from 10 to 30% by weight of C17 isoparaffins and from 60 to 90% by weight of C18 isoparaffins;
and/or the surfactants are chosen from alkoxylated acids, sorbitan esters, alkoxylated alcohols, and mixtures thereof;
the phytosanitary formulation has one or more of the following features:
   the phytosanitary formulation comprises:
      from 0.5 to 20% by weight, preferably from 1 to 15% by weight, more preferably from 2 to 10% by weight, of one or more surfactants,
      from 80 to 99.5% by weight, preferably from 85 to 99% by weight, more preferably from 90 to 98% by weight, of hydrocarbon fluid,
   relative to the total dry weight of the phytosanitary formulation,
   the phytosanitary formulation is in the form of an emulsifiable concentrate or an emulsion.

According to one embodiment, the phytosanitary formulation according to the invention is in the form of an emulsifiable concentrate comprising, preferably consisting of:
from 95 to 97% by weight of hydrocarbon fluid,
from 3 to 5% by weight, of one or more surfactants,
relative to the total weight of the phytosanitary formulation.

According to one embodiment, at least one surfactant of the phytosanitary formulation according to the invention is chosen from alkoxylated acids and alkoxylated alcohols and mixtures thereof, said formulation optionally further comprising at least one surfactant chosen from sorbitan esters.

The invention also relates to a phytosanitary treatment method for crops comprising the application of the phytosanitary formulation according to the invention, the application being preferably implemented by spraying on crops, e.g. by spraying or spreading, in particular using a drone.

The hydrocarbon fluid according to the invention is particularly stable. Indeed, said hydrocarbon fluid in particular has in particular excellent thermal stability, excellent oxidation stability as well as excellent UV stability, which allows for extending the shelf life of the phytosanitary formulation.

The hydrocarbon fluid according to the invention has low evaporation for a given flash point, which allows fluid loss by evaporation to be reduced, thus improving yields and the implementation of the phytosanitary treatment.

The invention provides a bio-sourced adjuvant with very low phytotoxicity.

The hydrocarbon fluid defined in the invention thus presents good compatibility with phytosanitary active ingredients.

The inventors have indeed discovered that the hydrocarbon fluid defined in the present invention presented both very good properties as a phytosanitary formulation adjuvant and as a phytosanitary formulation active ingredient.

### DETAILED DESCRIPTION OF THE INVENTION

The invention relates to the use of a hydrocarbon fluid as an adjuvant and/or as an active ingredient in a phytosanitary formulation comprising one or more surfactants, said hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C.

The hydrocarbon fluid implemented in the invention is typically bio-sourced.

As a preliminary note, it should be noted that, in the description and the following claims, the expression “comprised between” should be understood as including the cited limits.

As defined by the present invention, the word “paraffins” include isoparaffins and n-paraffins.

As defined by the present invention, the word “isoparaffins” refers to non-cyclic branched alkanes.

As defined by the present invention, the word “n-paraffins” refers to non-cyclic linear alkanes.

As defined by the present invention, the word “naphthenes” refers to cyclic (non-aromatic) alkanes.

### Hydrocarbon Fluid Implemented in the Invention:

The hydrocarbon fluid implemented according to the invention comprises a content of at least 80% by weight of isoparaffins, preferably at least 85% by weight, more preferably at least 90% by weight of isoparaffins, even at least 95% by weight, relative to the total weight of the hydrocarbon fluid.

The hydrocarbon fluid implemented according to the invention comprises a content less than or equal to 20% by weight of normal paraffins, preferably less than or equal to 15% by weight, more preferably less than or equal to 10% by weight of normal paraffins, even less than or equal to 5% by weight, relative to the total weight of the hydrocarbon fluid.

Preferably, the hydrocarbon fluid implemented according to the invention has an isoparaffin to normal paraffin weight ratio of at least 4:1, preferably at least 9:1, more preferably at least 12:1, preferably at least 15:1, even at least 19:1.

Preferably, the hydrocarbon fluid implemented according to the invention comprises, relative to the total weight of the hydrocarbon fluid, a content of naphthenic compounds less than or equal to 1% by weight, preferably less than or equal to 0.5% by weight and more preferably less than or equal to 100 ppm by weight.

According to one embodiment, the hydrocarbon fluid implemented according to the invention comprises at least 80% by weight of isoparaffins, less than 20% by weight of n-paraffins, less than 1% by weight of naphthenes and less than 100 ppm by weight of aromatics, relative to the total weight of the hydrocarbon fluid.

According to one embodiment, the hydrocarbon fluid implemented according to the invention comprises, relative to the total weight of the hydrocarbon fluid, a content of isoparaffins ranging from 90 to 100% by weight and a content of normal paraffins ranging from 0 to 10% by weight, preferably from 95 to 100% by weight of isoparaffins and from 0 to 5% by weight of normal paraffins and more preferably from 98 to 100% by weight of isoparaffins and from 0 to 2% by weight of normal paraffins.

According to a preferred embodiment, the hydrocarbon fluid implemented according to the invention comprises a content of isoparaffins ranging from 90 to 100% by weight, a content of normal paraffins ranging from 0 to 10% by weight and a content of naphthenes less than or equal to 1% by weight, relative to the total weight of the hydrocarbon fluid.

Preferably, the hydrocarbon fluid implemented according to the invention comprises a content of isoparaffins ranging from 95 to 100% by weight, a normal paraffins content ranging from 0 to 5% by weight and a content of naphthenes less than or equal to 0.5% by weight, relative to the total weight of the hydrocarbon fluid.

More preferably, the hydrocarbon fluid implemented according to the invention comprises a content of isoparaffins ranging from 98 to 100% by weight, from 0 to 2% by weight of normal paraffins and a content of naphthenes less than or equal to 100 ppm by weight, relative to the total weight of the hydrocarbon fluid.

The isoparaffins, normal paraffins, and naphthenes contents can be determined by any methods known to those skilled in the art, e.g. by gas chromatography.

The hydrocarbon fluid implemented according to the invention comprises less than 100 ppm by weight of aromatics, preferably less than 50 ppm by weight of aromatics, more preferably less than 20 ppm by weight of aromatics, relative to the total weight of the hydrocarbon fluid.

The aromatics content can be determined by any methods known to those skilled in the art, e.g. by UV spectrometry.

According to a preferred embodiment, the hydrocarbon fluid implemented according to the invention comprises a content of isoparaffins ranging from 90 to 100% by weight, a normal paraffins content ranging from 0 to 10% by weight, a content of naphthenes less than or equal to 1% by weight and a content of aromatics of less than or equal to 100 ppm by weight. Preferably, the hydrocarbon fluid implemented according to the invention comprises a content of isoparaffins ranging from 95 to 100% by weight, from 0 to 5% of normal paraffins by weight, a content of naphthenes less than or equal to 0.5% by weight and a content of aromatics of less than or equal to 50 ppm by weight. Preferably also, the hydrocarbon fluid implemented according to the invention comprises a content of isoparaffins ranging from 95 to 100% by weight, from 0 to 5% by weight of normal paraffins and a content of aromatics of less than or equal to 100 ppm by weight. More preferably, the hydrocarbon fluid implemented according to the invention comprises a content of isoparaffins ranging from 98 to 100% by weight, from 0 to 2% by weight of normal paraffins, a content of naphthenes less than or equal to 100 ppm by weight and a content of aromatics of less than or equal to 100 ppm by weight.

According to one embodiment, the hydrocarbon fluid implemented according to the invention has a biogenic carbon content of at least 90% by weight, preferably at least 95% by weight, more preferably at least 97% by weight, relative to the total weight of carbon atoms of the hydrocarbon fluid.

The biogenic carbon content (also called biological origin carbon) can be determined according to the ASTM D6866 standard of 2020.

According to one embodiment, the hydrocarbon fluid implemented according to the invention comprises at least 80% by weight of isoparaffins, less than 20% by weight of n-paraffins, less than 1% by weight of naphthenes and less than 100 ppm by weight of aromatics, relative to the total weight of the hydrocarbon fluid and has a biogenic carbon content of at least 90% by weight relative to the total weight of carbon atoms of the hydrocarbon fluid.

According to one embodiment, the hydrocarbon fluid implemented according to the invention comprises at least 90% by weight of isoparaffins, less than 10% by weight of n-paraffins, less than 1% by weight of naphthenes and less than 100 ppm by weight of aromatics, relative to the total weight of the hydrocarbon fluid and has a biogenic carbon content of at least 90% by weight relative to the total weight of carbon atoms of the hydrocarbon fluid.

The hydrocarbon fluid implemented according to the invention also preferably has an extremely low content of sulfur compounds, typically less than or equal to 5 ppm by weight, preferably less than or equal to 3 ppm by weight and more preferably less than or equal to 0.5 ppm by weight at a level too low to be detected by conventional low-sulfur analyzers.

The hydrocarbon fluid implemented according to the invention also preferably has a flash point greater than or equal to 110 °C, preferably greater than or equal to 120 °C and more preferably greater than or equal to 130 °C according to the ASTM D93 standard. A high flash point, typically greater than 110 °C, allows safety issues in particular to be addressed during storage and transport while too sensitive flammability of the hydrocarbon fluid to be avoided.

The hydrocarbon fluid implemented according to the invention also preferably has a vapor pressure at 20 °C less than or equal to 0.01 kPa.

According to one embodiment, the hydrocarbon fluid implemented according to the invention also preferably has a flash point greater than or equal to 110 °C according to the ASTM D93 standard and a vapor pressure at 20 °C less than or equal to 0.01 kPa.

Preferably, the hydrocarbon fluid implemented according to the invention has a flash point greater than or equal to 120 °C and a vapor pressure at 20 °C less than or equal to 0.01 kPa.

And more preferably, the hydrocarbon fluid implemented according to the invention has a flash point greater than or equal to 130 °C and a vapor pressure at 20 °C less than or equal to 0.01 kPa.

The hydrocarbon fluid implemented according to the invention also preferably has a kinematic viscosity at 40 °C less than or equal to 5 cSt, preferably less than or equal to 4 cSt, measured according to the ASTM D445 standard.

The hydrocarbon fluid implemented according to the invention has an initial boiling point and a final boiling point ranging from 260 to 320 °C, preferably from 260 to 300 °C.

The boiling points can be determined according to the ASTM D86 standard.

Preferably, the difference between the final boiling point and the initial boiling point ranges from 10 °C to 80 °C, preferably from 20 °C to 50 °C.

According to one embodiment, the hydrocarbon fluid implemented according to the invention comprises at least 80% by weight of isoparaffins, less than 1% by weight of naphthenes and less than 100 ppm by weight of aromatics, and has an initial boiling point and a final boiling point ranging from 260 to 320 °C.

According to a particularly preferred embodiment, the hydrocarbon fluid implemented according to the invention comprises at least 95% by weight of isoparaffins and less than 100 ppm by weight of aromatics, and has an initial boiling point and a final boiling point ranging from 260 to 320 °C.

According to one embodiment, the hydrocarbon fluid implemented according to the invention comprises, relative to the total weight of the hydrocarbon fluid:
from 20 to 80% by weight of C15 isoparaffins and from 20 to 80% by weight of C16 isoparaffins, said fluid may optionally comprise isoparaffins containing 14 carbon atoms or less and/or isoparaffins containing 17 carbon atoms or more; or
from 3 to 20% by weight of C15 isoparaffins, from 20 to 70% by weight of C16 isoparaffins, from 5 to 40% by weight of C17 isoparaffins, and from 5 to 40% by weight of C18 isoparaffins, said fluid may optionally comprise isoparaffins containing 14 carbon atoms or less and/or isoparaffins containing 19 carbon atoms or more; or
from 5 to 40% by weight of C17 isoparaffins and from 60 to 95% by weight of C18 isoparaffins, said fluid may optionally comprise isoparaffins containing 16 carbon atoms or less and/or isoparaffins containing 19 carbon atoms or more.

According to a particular embodiment, the hydrocarbon fluid implemented according to the invention comprises, relative to the total weight of the hydrocarbon fluid:
from 30 to 60% by weight of C15 isoparaffins and from 30 to 60% by weight of C16 isoparaffins, said fluid may optionally comprise isoparaffins containing 14 carbon atoms or less and/or isoparaffins containing 17 carbon atoms or more; or
from 5 to 15% by weight of C15 isoparaffins, from 30 to 60% by weight of C16 isoparaffins, from 10 to 30% by weight of C17 isoparaffins, and from 10 to 30% by weight of C18 isoparaffins, said fluid may optionally comprise isoparaffins containing 14 carbon atoms or less and/or isoparaffins containing 19 carbon atoms or more; or
from 10 to 30% by weight of C17 isoparaffins and from 60 to 90% by weight of C18 isoparaffins, said fluid may optionally comprise isoparaffins containing 16 carbon atoms or less and/or isoparaffins containing 19 carbon atoms or more.

The expression “CX isoparaffins” refers to isoparaffins containing X carbon atoms.

According to one embodiment, the hydrocarbon fluid implemented according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a content of aromatics of less than 100 ppm by weight, relative to the total weight of the hydrocarbon fluid.

According to one embodiment, the hydrocarbon fluid implemented according to the invention comprises from 10 to 30% by weight of C17 isoparaffins and from 60 to 90% by weight of C18 isoparaffins and has a content of aromatics of less than 100 ppm by weight, relative to the total weight of the hydrocarbon fluid.

According to one embodiment, the hydrocarbon fluid implemented according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a content of aromatics of less than 100 ppm by weight, relative to the total weight of the hydrocarbon fluid and said fluid has a biogenic carbon content of at least 95% by weight, relative to the total weight of carbon atoms of the hydrocarbon fluid.

According to one embodiment, the hydrocarbon fluid implemented according to the invention comprises from 10 to 30% by weight of C17 isoparaffins and from 60 to 90% by weight of C18 isoparaffins and has a content of aromatics of less than 100 ppm by weight, relative to the total weight of the hydrocarbon fluid and said fluid has a biogenic carbon content of at least 95% by weight, relative to the total weight of carbon atoms of the hydrocarbon fluid.

According to one embodiment, the hydrocarbon fluid implemented according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a content of aromatics of less than 50 ppm by weight, relative to the total weight of the hydrocarbon fluid and said fluid has a biogenic carbon content of at least 90% by weight, relative to the total weight of carbon atoms of the hydrocarbon fluid.

According to one embodiment, the hydrocarbon fluid implemented according to the invention comprises from 10 to 30% by weight of C17 isoparaffins and from 60 to 90% by weight of C18 isoparaffins and has a content of aromatics of less than 50 ppm by weight, relative to the total weight of the hydrocarbon fluid and said fluid has a biogenic carbon content of at least 90% by weight, relative to the total weight of carbon atoms of the hydrocarbon fluid.

The hydrocarbon fluid implemented according to the invention has a biodegradability of at least 60% at 28 days, measured according to the OECD 301B standard. Thereby, typically, the hydrocarbon fluid according to the invention will be said to be “readily biodegradable” in English.

By contrast, a product will be said to be “inherently biodegradable” in English if said product has a biodegradability ranging from 20 to less than 60% at 28 days according to the OECD 301 standard, e.g. according to the OECD 301B standard.

According to one embodiment, the hydrocarbon fluid implemented according to the invention has a biodegradability at 28 days of at least 70%, preferably at least 80%, measured according to the OECD 301B standard.

Preferably, the hydrocarbon fluid implemented according to the invention has a biodegradability of at least 60% at 28 days, measured according to the OECD 306 standard. The OECD 306 standard is more stringent than the OECD 301B standard.

### Method for Obtaining the Hydrocarbon Fluid:

The hydrocarbon fluid implemented according to the invention can be obtained as follows. The hydrocarbon fluid implemented according to the invention is a hydrocarbon fraction typically resulting from the conversion of biomass.

By resulting from the conversion of biomass, is meant a hydrocarbon fraction produced from raw materials of biological origin. The raw materials of biological origin can be chosen from vegetable oils, animal fats, fish oils, and mixtures thereof.

Preferably, the biological origin hydrocarbon fraction is obtained by a method comprising hydrodeoxygenation (HDO) treatment and isomerization (ISO) steps. The hydrodeoxygenation (HDO) step leads to the deformulation of the structures of the biological esters or triglyceride constituents, the elimination of oxygenated, phosphorated, and sulfur compounds, and the hydrogenation of olefinic bonds. The product resulting from the hydrodeoxygenation reaction is then isomerized. A fractionation step may preferably follow the hydrodeoxygenation and isomerization steps. Advantageously, the fractions of interest are then subjected to hydrodeoxygenation and distillation steps to obtain the specifications of the desired hydrocarbon fluid according to the invention.

This HDO/ISO method is implemented on a raw biological feedstock, also called biomass or raw material of biological origin, selected from the group consisting of vegetable oils, animal fats, fish oils, and their mixture. Suitable raw materials of biological origin are e.g. rapeseed oil, canola oil, tall oil, sunflower oil, soybean oil, hemp oil, olive oil, linseed oil, mustard oil, palm oil, peanut oil, castor oil, coconut oil, animal fats such as tallow, recycled cooking fats, raw materials from genetic engineering, and biological raw materials produced from microorganisms such as algae and bacteria. Condensation products, esters, or other derivatives obtained from raw biological materials can also serve as raw materials.

Preferably, the raw material of biological origin is an ester or a triglyceride derivative. This material is first subjected to a hydrodeoxygenation (HDO) step to decompose the structure of the constituent esters or triglycerides and eliminate oxygenated, phosphorus, and sulfur compounds concomitantly with the hydrogenation of olefinic bonds. This hydrodeoxygenation (HDO) step of the raw material of biological origin is followed by an isomerization of the product thus obtained leading to the branching of the hydrocarbon chain and an improvement of the paraffin properties at low temperatures.

During the HDO step, hydrogen and the raw material of biological origin are passed through a hydrodeoxygenation catalytic bed simultaneously or in back-flow. During the HDO step, the pressure and temperature are between 20 and 150 bars and between 200 and 500 °C respectively. Classical and known hydrodeoxygenation catalysts are used during this step. Optionally, the raw material of biological origin can be subjected to a mild pre-hydrogenation to avoid secondary reactions of double bonds before the HDO step. After the hydrodeoxygenation step, the product resulting from the reaction is subjected to an isomerization (ISO) step where hydrogen and the product, and optionally a mixture of n-paraffins, are passed over isomerization catalytic beds simultaneously or in back-flow. During the ISO step, the pressure and temperature are between 20 and 150 bars and between 200 and 500 °C respectively. Classical and known isomerization catalysts are used during this step.

Additional secondary methods can also be implemented (e.g. intermediate mixing, scavenging or the like).

The product resulting from the HDO/ISO steps can optionally be fractionated to obtain the fractions of interest.

Various HDO/ISO methods are described in the literature. The application WO2014/033762 describes a method comprising a pre-hydrogenation step, a hydrodeoxygenation (HDO) step, and an isomerization step operated in back-flow. The patent application EP1728844 describes a method for producing hydrocarbon compounds from a mixture of compounds of vegetable and animal origin. This method comprises a pre-treatment step of the mixture for the removal of contaminants, such as alkali metal salts, followed by a hydrodeoxygenation (HDO) step and an isomerization step. The patent application EP2084245 describes a method for producing a hydrocarbon mixture that can be used as diesel or in a diesel formulation by hydrodeoxygenation of a mixture of biological origin containing fatty acid esters optionally mixed with free fatty acids, e.g., vegetable oils such as sunflower oil, rapeseed oil, canola oil, palm oil, or pine oil, followed by hydroisomerization on specific catalysts. The patent application EP2368967 describes such a method and the product obtained by this method.

Advantageously, the raw material of biological origin contains less than 15 ppm of sulfur, preferably less than 8 ppm, more preferably less than 5 ppm and more preferably less than 1 ppm according to the EN ISO 20846 standard. Ideally, the feedstock does not comprise sulfur as a raw material of bio-sourced origin.

The deoxygenated and isomerized feedstock resulting from the HDO/ISO method is then hydrogenated, after optionally being fractionated to obtain a desired boiling range.

Preferably, the hydrogenation step is a catalytic hydrogenation step at a temperature from 80 to 180 °C and a pressure from 50 to 160 bars of a deoxygenated and isomerized biological origin feedstock (or fraction).

The hydrogen used in the hydrogenation unit is typically highly purified hydrogen. Highly purified refers to hydrogen with a purity, e.g., greater than 99%, although other grades can also be used.

The hydrogenation step is carried out using catalysts. Typical hydrogenation catalysts can be either in bulk or supported and can comprise the following metals: nickel, platinum, palladium, rhenium, rhodium, nickel tungstate, nickel-molybdenum, molybdenum, cobalt-molybdenum. The supports can be silica, alumina, silica-alumina, or zeolites.

A preferred catalyst is a nickel-based catalyst on an alumina support the specific surface area of which preferably ranges from 100 to 200 m²/g of catalyst or a bulk nickel-based catalyst. The hydrogenation conditions are typically as follows:
Pressure: 50 to 160 bars, preferably 80 to 150 bars and more preferably 90 to 120 bars;
Temperature: 80 to 180 °C, preferably 120 to 160 °C and more preferably 150 to 160 °C;
Liquid Hourly Space Velocity (LHSV): 0.2 to 5 hr⁻¹, preferably 0.4 to 3 hr⁻¹ and more preferably 0.5 to 0.8 hr⁻¹;
Hydrogen treatment rate: adapted to the conditions mentioned above and can go up to 200 Nm3/ton of feedstock to be treated.

The temperature in the reactors is typically between 150 and 160 °C with a pressure of about 100 bars while the liquid hourly space velocity is about 0.6 hr⁻¹ with a treatment rate adapted according to the quality of the feedstock to be treated and the parameters of the first hydrogenation reactor.

Hydrogenation can take place in one or more reactors in series. The reactors can comprise one or more catalytic beds. The catalytic beds are generally fixed catalytic beds.

The hydrogenation method preferably comprises two or three reactors, preferably three reactors and is more preferably carried out in three reactors in series.

The first reactor is used for the scavenging of sulfur compounds and the hydrogenation of essentially all unsaturated compounds and up to about 90% by weight of aromatic compounds. The product resulting from the first reactor substantially contains no sulfur compounds. At the second stage, i.e. in the second reactor, the hydrogenation of aromatics continues and up to 99% by weight of aromatics are thus hydrogenated.

The third stage in the third reactor is a finishing stage allowing aromatics contents less than 100 ppm to be obtained, preferably less than 50 ppm, more preferably less than 20 ppm.

It is possible to use a reactor that includes two or three catalytic beds or more. The catalysts may be present in variable or essentially equal amounts in each reactor; for three reactors, the amounts by weight may e.g. be 0.05-0.5/0.10-0.70/0.25-0.85, preferably 0.07-0.25/0.15-0.35/0.4-0.78 and more preferably 0.10-0.20/0.20-0.32/0.48-0.70.

It is also possible to use one or two hydrogenation reactors instead of three.

It is also possible that the first reactor is composed of twin reactors implemented alternately. This operating mode allows in particular easy loading and unloading of catalysts: when the first reactor comprises the catalyst saturated first (substantially all the sulfur is trapped on and/or in the catalyst) said catalyst must be changed often.

A single reactor can also be used wherein two, three catalytic beds or more are installed.

It may be necessary to insert quench boxes in the recycle system or between the reactors, to cool the effluents from one reactor to another or from one catalytic bed to another to control the temperatures and the hydrothermal balance of each reaction. According to a preferred embodiment, there is no intermediate cooling nor quenching.

According to one embodiment, the product resulting from the method and/or the separated gases are at least partially recycled in the hydrogenation reactor feed system. This dilution helps to maintain the exothermicity of the reaction within controlled limits, particularly at the first stage. Recycling also allows for heat exchange before the reaction and also better temperature control.

The effluent from the hydrogenation unit mainly contains the hydrogenated product and hydrogen. Flash separators are used to separate the effluents into a gas phase, mainly residual hydrogen, and a liquid phase, mainly hydrogenated hydrocarbon fractions. The method can be carried out using three flash separators, one at high pressure, one at intermediate pressure, and one at low pressure very close to atmospheric pressure.

The gaseous hydrogen collected at the top of the flash separators can be recycled in the hydrogenation unit feed system or at different levels in the hydrogenation units between the reactors.

According to one embodiment, the final product is separated at atmospheric pressure. Said final product then directly feeds a vacuum fractionation unit. Preferably, the fractionation will be carried out at a pressure ranging from 10 to 50 mbars and more preferably at about 30 mbars.

Fractionation can be carried out so that it is possible to simultaneously withdraw various hydrocarbon fluids from the fractionation column and that the boiling temperature thereof can be predetermined.

By adapting the feedstock through the initial and final boiling points thereof, the hydrogenation reactors, separators, and fractionation unit can therefore be directly connected without the need to use intermediate tanks. This integration of hydrogenation and fractionation allows for optimized thermal integration associated with a reduction in the number of devices and energy savings.

Thereby, according to one embodiment of the invention, the hydrocarbon fluid implemented in the invention is obtained by a method comprising a catalytic hydrogenation step of a biomass that has undergone hydrodeoxygenation and hydroisomerized, said hydrogenation step being implemented at a temperature ranging from 80 to 180 °C and a pressure from 50 to 160 bars, preferably at a temperature ranging from 120 to 160 °C and a pressure ranging from 80 to 150 bars, more preferably at a temperature ranging from 150 to 160 °C and a pressure ranging from 90 to 120 bars.

According to a particular embodiment, the hydrocarbon fluid implemented in the invention is obtained by a method comprising:
a hydrodeoxygenation step followed by a hydroisomerization step of a biomass to obtain a hydrodeoxygenated and hydroisomerized biomass,
a catalytic hydrogenation step of the hydrodeoxygenated and hydroisomerized biomass, said hydrogenation step being implemented at a temperature ranging from 80 to 180 °C and a pressure of 50 to 160 bars, preferably at a temperature ranging from 120 to 160 °C and a pressure ranging from 80 to 150 bars, more preferably at a temperature ranging from 150 to 160 °C and a pressure ranging from 90 to 120 bars,
the biomass being preferably chosen from vegetable oils, animal fats, fish oils, and mixtures thereof.

The hydrocarbon fluid implemented according to the invention is ideally derived from the treatment of raw materials of biological origin. The term “biogenic carbon” or “bio-carbon” indicates that the carbon is of natural origin and comes from a biomaterial, as indicated below. The bio-carbon content, the biogenic carbon content, and the biomaterial content are expressions indicating the same value. A renewable or biomaterial is an organic material wherein the carbon is derived from recently fixed CO₂ (on a human scale) by photosynthesis from the atmosphere. A biomaterial (100% natural origin carbon) has an isotopic ratio ¹⁴C/¹²C greater than 10⁻¹², typically about 1.2×10⁻¹², while a fossil material has a zero ratio. Indeed, the isotopic ¹⁴C formed in the atmosphere is then integrated by photosynthesis, on a time scale of a few tens of years at most. The half-life of ¹⁴C is 5730 years. Thus, materials derived from photosynthesis, namely phytosanitary products in general, necessarily have a maximum content of ¹⁴C isotope.

### Additives

The phytosanitary formulation implemented in the invention comprises one or more surfactants.

Preferably, the phytosanitary formulation comprises from 0.5 to 20% by weight, preferably from 1 to 15% by weight, more preferably from 2 to 10% by weight of one or more surfactants, relative to the total weight of the phytosanitary formulation.

As defined by the present invention, the term “surfactant” also includes emulsifiers.

The phytosanitary formulation implemented in the invention can be in the form of an emulsifiable concentrate or an emulsion.

According to one embodiment, when it is in the form of an emulsifiable concentrate, the phytosanitary formulation comprises, or even consists of:
85 to 99% by weight, preferably from 90 to 98% by weight, of hydrocarbon fluid,
1 to 14% by weight, preferably from 2 to 8% by weight, of surfactants,
optionally from 0.05 to 2% by weight, preferably from 0.1 to 1% by weight, of water,
relative to the total weight of the emulsifiable concentrate.

The emulsifiable concentrate can then be put in the form of an emulsion during the final use, i.e. during the phytosanitary treatment.

When the hydrocarbon fluid is used as an adjuvant, the emulsification may be implemented before, during, or after the addition of the phytosanitary active ingredient(s), before phytosanitary treatment.

When the hydrocarbon fluid is used as an active ingredient, the emulsification of the emulsifiable concentrate may be implemented just before the phytosanitary treatment. According to this embodiment, the phytosanitary formulation implemented during the phytosanitary treatment preferably does not comprise a phytosanitary active ingredient different from the hydrocarbon fluid.

When the phytosanitary formulation is in the form of an emulsion, the phytosanitary formulation can be an oil-in-water or water-in-oil emulsion.

According to one embodiment, when the phytosanitary formulation is in the form of an emulsion, the phytosanitary formulation comprises, or even consists of:
40 to 80% by weight, preferably from 50 to 70% by weight, of hydrocarbon fluid,
0.5 to 5% by weight, preferably from 1 to 3% by weight, of surfactants,
from 15 to 59.5% by weight, preferably from 29 to 49% by weight, of water,
relative to the total weight of the emulsion.

According to one embodiment, the phytosanitary formulation implemented in the invention comprises one or more surfactants chosen from non-ionic surfactants.

According to one embodiment, the phytosanitary formulation implemented in the invention comprises one or more surfactants chosen from an alkoxylated acid, a sorbitan ester, an alkoxylated alcohol, and mixtures thereof.

The alkoxylated acid can be an acid or polyacid, preferably monoacid, saturated or unsaturated, preferably unsaturated, including one or more alkoxylated units.

Preferably, the alkoxylated acid is an oleic acid including one or more alkoxylated units, preferably ethoxylated. Thus, preferably, the alkoxylated acid is an ethoxylated oleic acid.

The alkoxylated alcohol can be a monoalcohol or polyol, preferably monoalcohol, saturated or unsaturated, preferably saturated, including one or more alkoxylated units.

Preferably, the alkoxylated alcohol is an isotridecanol including one or more alkoxylated units, preferably ethoxylated. Thus, preferably, the alkoxylated alcohol is an ethoxylated isotridecanol.

In the context of the present invention, ethoxylation is the chemical reaction wherein ethylene oxide is added to a labile hydrogen compound to produce surfactants. The labile hydrogen compound is generally an alcohol, a phenol, or a carboxylic acid.

In one embodiment, the number of alkoxylations, or ethoxylations, ranges from 1 to 10, preferably from 1 to 5, and more preferably from 1 to 3.

A sorbitan ester, relates to a derivative of sorbitan by esterification of one or more of its alcohol or phenol functions. As an example and without limitation, sorbitan monostearate, sorbitan tristearate, sorbitan monolaurate, sorbitan monopalmitate, sorbitan trioleate, and sorbitan monooleate may be cited.

Preferably, the sorbitan ester is chosen from sorbitan trioleate and sorbitan monooleate and mixtures thereof.

According to one embodiment, the phytosanitary formulation comprises:
at least one surfactant chosen from ethoxylated unsaturated acids,
at least one surfactant chosen from sorbitan esters.

According to one embodiment, the phytosanitary formulation comprises:
at least one surfactant chosen from ethoxylated oleic acid,
at least one surfactant chosen from sorbitan oleate.

According to one embodiment, the phytosanitary formulation comprises:
from 1 to 8% by weight, preferably from 1.5 to 5% by weight, of ethoxylated unsaturated acids, preferably ethoxylated oleic acids,
from 0.05 to 3% by weight, preferably from 0.1 to 2% by weight, of sorbitan esters, preferably sorbitan oleates,
relative to the total weight of the phytosanitary formulation.

### Use as an Adjuvant:

The hydrocarbon fluid, in mixture with one or more surfactants, can be used as an adjuvant in a phytosanitary formulation.

As defined by the present invention, a use of a product “as an adjuvant in a phytosanitary formulation” means that the phytosanitary formulation is intended to be mixed with an active ingredient for phytosanitary treatment, said adjuvant product then having the role of improving the effectiveness of the active ingredient. One can then speak of a so-called “booster” effect.

According to one embodiment, the hydrocarbon fluid defined in the invention is used as an enhancer of the effectiveness of the active ingredient for phytosanitary treatment.

The active ingredient can be chosen from herbicides, insecticides, acaricides, fungicides, and biostimulants, preferably from herbicides.

When the active ingredient of the phytosanitary formulation is a herbicide, the hydrocarbon fluid can be used as an agent for improving the herbicidal effectiveness of the phytosanitary formulation.

For example, the active ingredient can be chosen from tribenuron-methyl, diclofop-methyl, Fenoxaprop-P-ethyl, Fluazifop-P-butyl, Haloxyfop, Clethodim, Cycloxydim.

When the hydrocarbon fluid is used as an adjuvant, then preferably, after adding water and the active ingredient(s), the phytosanitary formulation (final formulation for treatment) comprises:
from 1 to 5% by volume of the emulsifiable concentrate comprising the hydrocarbon fluid and one more surfactants,
from 1 to 15% by volume of active ingredient, preferably chosen from herbicides, insecticides, acaricides, fungicides, and biostimulants, preferably from herbicides,
from 80 to 98% by volume of water,
relative to the total volume of the phytosanitary formulation.

### Use as an Active Ingredient

The hydrocarbon fluid, in a mixture with one or more surfactants, may be used as an active ingredient in a phytosanitary formulation.

As defined by the present invention, a use of a product “as an active ingredient in a phytosanitary formulation” means that said product is an active ingredient for phytosanitary treatment. Typically, according to this embodiment, the phytosanitary formulation will not comprise active ingredients for phytosanitary treatment other than the hydrocarbon fluid according to the invention during the phytosanitary treatment.

As defined by the present invention, the expression “active ingredient” will mean active ingredient for phytosanitary treatment.

According to one embodiment, the hydrocarbon fluid of the invention is used as an active ingredient chosen from insecticides, acaricides, fungicides, and biostimulants, preferably from acaricides and fungicides.

Thereby, the hydrocarbon fluid, in a mixture with one or more surfactants, is particularly useful as an acaricide and/or fungicide.

When the hydrocarbon fluid is used as an active ingredient, then preferably, the phytosanitary formulation comprises:
from 95 to 97% by weight of hydrocarbon fluid,
from 3 to 5% by weight of surfactants,
relative to the total dry weight of the phytosanitary formulation.

When the hydrocarbon fluid is used as an active ingredient, then preferably, the phytosanitary formulation consists of:
from 95 to 97% by weight of hydrocarbon fluid,
from 3 to 5% by weight of surfactants,
relative to the total dry weight of the phytosanitary formulation.

### Use as an Adjuvant and Active Ingredient

The hydrocarbon fluid, in a mixture with one or more surfactants, may be used both as an adjuvant and as an active ingredient.

As defined by the present invention, a use of a product “as an adjuvant and active ingredient in a phytosanitary formulation” means that said product could have both functions.

The phytosanitary formulation according to the invention is used for the preventive and/or curative treatment of crop diseases.

### Phytosanitary Formulation

The invention also concerns a phytosanitary formulation comprising:
a hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C, and
one or more surfactants,
   characterized in that:
a) the formulation further comprises an active ingredient chosen from herbicides, insecticides, acaricides, fungicides, and biostimulants, and/or
b) the weight ratio between the hydrocarbon fluid and the surfactants ranges from 18 to 40.

Preferably, the hydrocarbon fluid implemented in the phytosanitary formulation has one or more of the features defined in the present invention in the context of the use according to the invention.

Preferably, the phytosanitary formulation according to the invention is in the form of an emulsifiable concentrate or an emulsion.

According to a first embodiment, the phytosanitary formulation according to the invention comprises:
a hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C,
one or more surfactants, and
an active ingredient chosen from herbicides, insecticides, acaricides, fungicides, and biostimulants, preferably from herbicides.

According to this first embodiment, the active ingredient is different from the hydrocarbon fluid defined in the invention.

Preferably, according to this embodiment, the phytosanitary formulation comprises:
from 19.9 to 60% by weight, preferably from 24.5 to 50% by weight, of hydrocarbon fluid,
from 0.1 to 3% by weight, preferably from 0.5 to 2% by weight, of surfactants,
from 39.9 to 80 by weight, preferably from 49.5 to 75% by weight, of active ingredient,
relative to the total dry weight of the phytosanitary formulation.

According to a particular embodiment, the phytosanitary formulation according to the invention comprises an active ingredient, different from the hydrocarbon fluid defined in the invention and chosen from herbicides, insecticides, acaricides, fungicides, and biostimulants, preferably from herbicides, and said phytosanitary formulation according to the invention having a weight ratio between the hydrocarbon fluid and the surfactants of 18 to 40, preferably from 19 to 35, preferably from 20 to 35, more preferably from 25 to 35, even from 30 to 35.

According to a second embodiment of the invention, the phytosanitary formulation according to the invention comprises:
a hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C,
one or more surfactants,
the weight ratio between the hydrocarbon fluid and the surfactants ranging from 18 to 40, preferably from 19 to 35, preferably from 20 to 35, more preferably from 25 to 35, even from 30 to 35.

According to this particular embodiment, the phytosanitary formulation according to the invention may be free of active ingredient (phytosanitary), different from the hydrocarbon fluid defined in the invention.

According to one embodiment, the phytosanitary formulation according to the invention is in the form of an emulsifiable concentrate and comprises:
from 80 to 97% by weight, preferably from 90 to 97% by weight, more preferably from 95 to 97% by weight, of hydrocarbon fluid,
from 3 to 20% by weight, preferably from 3 to 10% by weight, more preferably from 3 to 5% by weight, of surfactants,
relative to the total dry weight of the phytosanitary formulation,
formulation wherein the weight ratio between the hydrocarbon fluid and the surfactants ranges from 18 to 40, preferably from 19 to 35, preferably from 20 to 35, more preferably from 25 to 35, even from 30 to 35.

According to one embodiment, the phytosanitary formulation implemented during the phytosanitary treatment according to the invention comprises relative to the total volume of the phytosanitary formulation:
from 0.5 to 10% by volume, preferably from 1 to 5% by volume, of emulsifiable concentrate, said concentrate comprising:
   from 80 to 97% by weight, preferably from 90 to 97% by weight, more preferably from 95 to 97% by weight, of hydrocarbon fluid,
   from 3 to 20% by weight, preferably from 3 to 10% by weight, more preferably from 3 to 5% by weight, of surfactants,
   relative to the total dry weight of the emulsifiable concentrate,
from 0.5 to 15% by volume, preferably from 1 to 10% by volume, of active ingredient, preferably chosen from herbicides, insecticides, acaricides, fungicides, and biostimulants, preferably from herbicides,
from 80 to 98% by volume, preferably from 85 to 98% by volume, of water.

According to one embodiment, the phytosanitary formulation implemented during the phytosanitary treatment according to the invention comprises relative to the total volume of the phytosanitary formulation:
from 1 to 20% by volume, preferably from 2 to 15% by volume, of emulsifiable concentrate, said concentrate comprising:
   from 80 to 97% by weight, preferably from 90 to 97% by weight, more preferably from 95 to 97% by weight, of hydrocarbon fluid,
   from 3 to 20% by weight, preferably from 3 to 10% by weight, more preferably from 3 to 5% by weight, of surfactants,
   relative to the total dry weight of the emulsifiable concentrate,
from 80 to 99% by volume, preferably from 85 to 98% by volume, of water,
said phytosanitary formulation being free of active ingredient (phytosanitary) different from the hydrocarbon fluid.

When said phytosanitary formulation is in the form of an emulsifiable concentrate, the phytosanitary formulation comprises according to a particular embodiment:
85 to 99% by weight, preferably from 90 to 98% by weight, of hydrocarbon fluid,
1 to 14% by weight, preferably from 2 to 8% by weight, of surfactants,
optionally from 0.05 to 2% by weight, preferably from 0.1 to 1% by weight, of water relative to the total weight of the emulsifiable concentrate,
it being understood that the weight ratio between the hydrocarbon fluid and the surfactants ranges from 18 to 40, preferably from 19 to 35, preferably from 20 to 35, more preferably from 25 to 35, even from 30 to 35.

When the phytosanitary formulation is in the form of an emulsifiable concentrate, the phytosanitary formulation comprises according to one embodiment:
from 19.9 to 60% by weight, preferably from 24.5 to 50% by weight, of hydrocarbon fluid,
from 0.1 to 3% by weight, preferably from 0.5 to 2% by weight, of surfactants,
optionally from 0.05 to 2% by weight, preferably from 0.1 to 1% by weight, of water
from 39.9 to 80 by weight, preferably from 49.5 to 75% by weight, of active ingredient,
relative to the total weight of the emulsifiable concentrate.

According to one embodiment, when the phytosanitary formulation is in the form of an emulsion, the phytosanitary formulation according to the invention comprises, or even consists of:
from 40 to 80% by weight, preferably from 50 to 70% by weight, of hydrocarbon fluid,
from 0.5 to 5% by weight, preferably from 1 to 3% by weight, of surfactants,
from 1 to 59.5% by weight, preferably from 29 to 49% by weight, of water,
relative to the total weight of the emulsion,
it being understood that the weight ratio between the hydrocarbon fluid and the surfactants ranges from 18 to 40, preferably from 19 to 35, preferably from 20 to 35, more preferably from 25 to 35, even from 30 to 35.

Preferably, according to this embodiment, said emulsion will be free of active ingredient (phytosanitary) different from the hydrocarbon oil

When it is in the form of an emulsion, it can be an oil-in-water or water-in-oil emulsion.

The surfactant(s) of the phytosanitary formulation can be as defined in the context of the use according to the invention.

The hydrocarbon fluid of the phytosanitary formulation can comprise one or more of the features defined in the context of the use according to the invention.

According to one embodiment, the phytosanitary formulation according to the invention comprises relative to the total dry weight of the phytosanitary formulation:
at least 40% by weight of a hydrocarbon fluid, said hydrocarbon fluid comprising at least 90% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C,
at least 0.1% by weight, of at least one surfactant chosen from ethoxylated unsaturated acids, and
at least 0.025% by weight of at least one surfactant chosen from sorbitan esters,
   it being understood that:
   a) the formulation further comprises an active ingredient chosen from herbicides, insecticides, acaricides, fungicides, and biostimulants, and/or
   b) the weight ratio between the hydrocarbon fluid and the surfactants ranges from 18 to 40, preferably from 19 to 35, preferably from 20 to 35, more preferably from 25 to 35, even from 30 to 35.

According to one embodiment, the phytosanitary formulation comprises relative to the total dry weight of the phytosanitary composition:
at least 80% by weight of a hydrocarbon fluid, said hydrocarbon fluid comprising at least 90% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C,
from 1 to 8% by weight, of at least one surfactant chosen from ethoxylated oleic acid,
from 0.05 to 3% by weight of at least one surfactant chosen from sorbitan oleate,
   it being understood that the weight ratio between the hydrocarbon fluid and the surfactants ranges from 18 to 40,
   preferably, said phytosanitary formulation is free of active ingredient (phytosanitary) different from the hydrocarbon fluid.

According to one embodiment, the phytosanitary formulation comprises relative to the total dry weight of the phytosanitary formulation:
from 80 to 99% by weight, preferably from 85 to 98% by weight of hydrocarbon fluid, said hydrocarbon fluid comprising at least 90% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C,
from 1 to 8% by weight, preferably from 1.5 to 5% by weight, of ethoxylated unsaturated acids, preferably ethoxylated oleic acids,
from 0.05 to 3% by weight, preferably from 0.1 to 2% by weight, of sorbitan esters, preferably sorbitan oleates,
   relative to the total weight of the phytosanitary formulation,
   it being understood that b) the weight ratio between the hydrocarbon fluid and the surfactants ranges from 18 to 40, preferably from 19 to 35, preferably from 20 to 35, more preferably from 25 to 35, even from 30 to 35,
   preferably, said phytosanitary formulation is free of active ingredient (phytosanitary) different from the hydrocarbon fluid.

### Phytosanitary Treatment

The invention also relates to a phytosanitary treatment method for crops comprising the application of the phytosanitary formulation according to the invention on crops.

Preferably, the application is implemented by spraying on crops, e.g. by spraying or spreading, in particular using a drone.

The phytosanitary treatment according to the invention can be a herbicidal and/or insecticidal and/or acaricidal and/or fungicidal and/or biostimulant treatment.

The features described above in the context of the use according to the invention and in the context of the phytosanitary formulation according to the invention also apply to the phytosanitary treatment according to the invention.

### EXAMPLES

In the following of the present description, examples are given as illustrative of the present invention and are in no way intended to be limiting.

### Example 1: Description of the Phytosanitary Formulation

A hydrocarbon HC fluid was prepared according to a method as described in the present invention, by HDO/ISO of a biomass followed by a hydrogenation step.

Table 1 summarizes the physicochemical properties of the hydrocarbon fluid.

TABLE 1

| | HC Fluid |
|---|---|
| % iso paraffins (weight/weight) | 98% |
| % n-paraffins (weight/weight) | 2% |
| % naphthenics (weight/weight) | 0 |
| Aromatics (ppm) | <50 |
| Sulfur (ppm) | <1 ppm |
| Biogenic carbons content (%) | 100 |
| Initial boiling point (°C) | 260 |
| Final boiling point (°C) | 320 |
| Biodegradability (28 days) (%) | 89 |
| Density at 15 °C (kg/m3) | 785 |
| Flash point (°C) | 135 |
| Pour point (°C) | −60 |
| Kinematic Viscosity at 40 °C (cSt) | 3.5 |

The following standards and methods were used to measure the above properties:
flash point: EN ISO 2719,
density at 15 °C: EN ISO 1185,
viscosity at 40 °C: EN ISO 3104,
Boiling point: ASTM D86,
biodegradability: OECD 301B method,
pour point: ASTM D5950.

### Preparation of the Emulsifiable Concentrate:

An emulsifiable concentrate CEInv was prepared with the following proportions:
96.9% by weight of HC fluid,
2.45% by weight of ethoxylated oleic acid,
0.5% by weight of sorbitan oleate,
0.15% by weight of water.

### Example 2: Use as an Adjuvant

The emulsifiable concentrate CEInv according to example 1 was tested as an adjuvant in this example 2.

The active ingredient used is a tribenuron-methyl type herbicide.

In this example, 2 liters of the emulsifiable concentrate CEInv according to example 1 were added to 200 liters of water. The active ingredient was added for a treatment of 37.5 g of herbicide/ha.

The treatment was implemented by 300 liters of water per hectare.

The control corresponded to a treatment with a phytosanitary formulation comprising only the herbicide, without adjuvant or surfactant.

The phytosanitary treatment was tested on the following 4 species, on cereal crops infected according to the indicated infestation rate:
DIPMU=Diplotaxis muralis (16.0 plants/m²),
CHYCS=Chrysantenum coronarium (12.3 plants/m²),
POLAV=Polygonum aviculare (5.0 plants/m²),
PAPRH=Papaver rhoeas (6.5 plants/m²).

The proportion of species eliminated was determined 106 days after the application of the phytosanitary formulation.

The percentages of species eliminated are indicated in Table 2.

TABLE 2

| | Control | CEInv |
|---|---|---|
| DIPMU | 77.5 | 86.3 |
| CHYCS | 75 | 87.5 |
| POLAV | 77.5 | 81.3 |
| PAPRH | 78.8 | 93.8 |

As the results show, the phytosanitary formulation comprising the adjuvant according to the invention shows better results than the control formulation comprising only the herbicide.

The adjuvant according to the invention thus has a booster effect on the herbicidal effect of the active ingredient.

In addition, the results showed:
no phytotoxic symptoms of the phytosanitary formulation according to the invention,
that the treated crops continued to develop normally,
that at the time of harvest, no significant difference was observed between the control and the phytosanitary formulation according to the invention on the parameters: yield, moisture content, Crop yield expressed in Tons per Ha at a grain moisture rate of 14%.

### Example 3: Use as an Acaricidal Active Ingredient

Tests were also carried out to evaluate the effectiveness and selectivity of the hydrocarbon fluid according to the invention as an acaricidal active ingredient.

Thus, the emulsifiable concentrate CEInv according to example 1 was tested as an acaricidal active ingredient in this example 3.

The effectiveness on the mite species Tetranychus urticae was tested on cucurbits.

Table 3 below summarizes the treatment conditions.

TABLE 3

| Test | Nature of the | | Treatment rate |
|---|---|---|---|
| number | treatment | Form of treatment | Application |
| 1 | No treatment | | |
| 2 | Emulsion “active | Emulsifiable | 30 l of CEInv/ha |
| | ingredient” | concentrate | 1000 liters of water/ha |
| 3 | Emulsion “active | Emulsifiable | 15 l of CEInv/ha |
| | ingredient” | concentrate | 1000 liters of water/ha |
| 4 | Emulsion “active | Emulsifiable | 7.5 l of CEInv/ha |
| | ingredient” | concentrate | 1000 liters of water/ha |

A first test was implemented at the time of the mobile stage of the mites (adults and nymphs). The acaricidal effectiveness was determined according to the H&T method (Henderson and Tilton). The effectiveness results are indicated in Table 4 below.

TABLE 4

| | |
|---|---|
| | Number of days after application during |
| Test | the mobile development phase |

| number | 5 | 7 | 14 |
|---|---|---|---|
| 1 | 0 | 0 | 0 |
| 2 | 45.9 | 48.9 | 58.2 |
| 3 | 40.4 | 42.4 | 51.7 |
| 4 | 43.5 | 43.6 | 48.5 |

As the results in Table 4 above show, the hydrocarbon fluid according to the invention has an acaricidal effect with an effectiveness of 40 to 58% for all treatment rates during the mobile development phases.

Indeed, the hydrocarbon fluid, implemented in an emulsifiable concentrate, provides good acaricidal effectiveness on the mite species Tetranychus urticae during the mobile development phases.

A second test was implemented on the eggs of the mites (species Tetranychus urticae). The acaricidal effectiveness was determined according to the H&T method (Henderson and Tilton). The effectiveness results are indicated in Table 5 below.

TABLE 5

| | |
|---|---|
| Test | Number of days after application on the eggs |

| number | 5 | 7 | 14 |
|---|---|---|---|
| 1 | 0 | 0 | 0 |
| 2 | 46.4 | 38.5 | 43.7 |
| 3 | 43.7 | 34.8 | 33.6 |
| 4 | 47.0 | 37.1 | 48.7 |

As the results in Table 5 above show, the hydrocarbon fluid according to the invention has an acaricidal effect with an effectiveness of 33 to 48% for all treatment rates on the eggs of the mites.

Indeed, the hydrocarbon fluid, implemented in an emulsifiable concentrate provides good acaricidal effectiveness on the eggs of the mite species Tetranychus urticae.

In addition, the results showed no phytotoxic symptoms of the phytosanitary formulation according to the invention.

### Example 4: Use as a Fungicidal Active Ingredient

Tests were also carried out to evaluate the effectiveness and selectivity of the hydrocarbon fluid according to the invention as a fungicidal active ingredient.

Thus, the emulsifiable concentrate CEInv according to example 1 was tested as a fungicidal active ingredient in this example 4.

The effectiveness on the fungus species Leveillula taurica was tested on the phytosanitary species Solanaceae.

The disease level was high. The average of infected plants on untreated control plots ranged from 62.5% at 0 days after treatment (just before application) to 100% at 28 days after treatment.

The average of the plant area damaged by the disease ranged from 3.6% at 0 days after treatment to 61.8% at 28 days after treatment.

Table 6 below summarizes the treatment conditions. The paraffinic oil was a fossil-origin oil (non-biosourced).

TABLE 6

| Test | Nature of the | Form of | Treatment rate |
|---|---|---|---|
| number | treatment | treatment | Application |
| 1 | No treatment | | |
| 2 | Emulsion “active | Emulsifiable | 1.5 l of CEInv/100 |
| | ingredient” | concentrate | liters of water |
| | | | 1000 liters of water/ha |
| 3 | Emulsion “active | Emulsifiable | 3 l of CEInv/100 liters |
| | ingredient” | concentrate | of water |
| | | | 1000 liters of water/ha |
| 4 | Paraffinic oil | Emulsifiable | 1.5 l of oil/100 liters |
| | | concentrate | of water |
| | | | 1000 liters of water/ha |

The antifungal effectiveness was determined according to the Abbott method. The effectiveness results are indicated in Table 7 below as a percentage.

TABLE 7

| Test | Number of days after application | | | | | | |
|---|---|---|---|---|---|---|---|
| number | 3 | 6 | 9 | 12 | 15 | 18 | 21 |
| 1 | 0 | 0 | 0 | 0 | 0 | 0 | 0 |
| 2 | 78.1 | 76.3 | 80.4 | 85.2 | 80.9 | 69.3 | 61.9 |
| 3 | 91.7 | 91.2 | 90.2 | 87.3 | 81.1 | 75.6 | 75.4 |
| 4 | 75.7 | 84.8 | 87.5 | 90.9 | 90.0 | 90.8 | 89.8 |

Table 7 above shows that the hydrocarbon fluid according to the invention, implemented with surfactants in an emulsifiable concentrate, provided a good level of control of the disease progression throughout the trial since with a dose of 1.5%, the effectiveness varied from 61% to 85%.

Table 7 above also shows that the hydrocarbon fluid according to the invention, implemented with surfactants in an emulsifiable concentrate, provided an excellent level of disease control up to 18 days after application since the effectiveness varied from 81% to 91% during this period with a dose of 3%. Beyond 18 days, the effectiveness remained good even if said effectiveness decreased to 75%.

Table 7 above also shows that the formulation comprising the hydrocarbon fluid defined in the invention provided better effectiveness at the beginning of phytosanitary treatment than a fossil-origin paraffinic oil (non-biosourced).

In addition, the results showed no phytotoxic symptoms of the phytosanitary formulation according to the invention.

1. A use of a hydrocarbon fluid as an adjuvant and/or as an active ingredient in a phytosanitary formulation comprising one or more surfactants, said hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C.

2. The use according to claim 1, wherein the phytosanitary formulation comprises:
from 0.5 to 20% by weight, preferably from 1 to 15% by weight, more preferably from 2 to 10% by weight, of one or more surfactants,
from 80 to 99.5% by weight, preferably from 85 to 99% by weight, more preferably from 90 to 98% by weight, of hydrocarbon fluid,
relative to the total dry weight of the phytosanitary formulation.

3. The use according to claim 1, wherein the surfactant(s) are chosen from alkoxylated acids, sorbitan esters, alkoxylated alcohols, and mixtures thereof.

4. The use according to claim 1, wherein the hydrocarbon fluid comprises relative to the total weight of the hydrocarbon fluid:
at least 85% by weight of isoparaffins, preferably at least 90% by weight, more preferably at least 95% by weight, and/or
at most 20% by weight of normal paraffins, preferably at most 10% by weight, more preferably at most 5% by weight, and/or
at most 1% by weight of naphthenes, and/or
less than 50 ppm by weight of aromatics.

5. The use according to claim 1, wherein the hydrocarbon fluid has:
a flash point greater than or equal to 110 °C, preferably greater than or equal to 120 °C, or even greater than or equal to 130 °C according to the ASTM D93 standard, and/or
a kinematic viscosity at 40 °C less than or equal to 5 cSt, preferably less than or equal to 4 cSt, and/or
a biogenic carbon content of at least 90% by weight, preferably at least 95% by weight, more preferably at least 97% by weight, relative to the total weight of the carbon atoms of the hydrocarbon fluid, and/or
a difference between the final boiling point and the initial boiling point ranging from 10 °C to 60 °C, preferably from 20 °C to 50 °C.

6. The use according to claim 1, wherein the hydrocarbon fluid comprises, relative to the total weight of the hydrocarbon fluid:
from 5 to 15% by weight of C15 isoparaffins, from 30 to 60% by weight of C16 isoparaffins, from 10 to 30% by weight of C17 isoparaffins, and from 10 to 30% by weight of C18 isoparaffins, or
from 10 to 30% by weight of C17 isoparaffins and from 60 to 90% by weight of C18 isoparaffins.

7. The use according to claim 1, wherein the phytosanitary formulation is in the form of an emulsifiable concentrate or an emulsion.

8. The use according to claim 1, as an adjuvant in a phytosanitary formulation, said phytosanitary formulation further comprising at least one active ingredient chosen from herbicides, insecticides, acaricides, fungicides, and biostimulants, preferably from herbicides.

9. The use according to claim 1, as an active ingredient in a phytosanitary formulation, said active ingredient being chosen from insecticides, acaricides, fungicides, and biostimulants, preferably said phytosanitary formulation being free of active ingredient chosen from herbicides, insecticides, acaricides, fungicides, biostimulants, different from the hydrocarbon fluid, more preferably said phytosanitary formulation being free of phytosanitary active ingredient different from the hydrocarbon fluid.

10. The use according to claim 1, wherein the phytosanitary formulation is used for the preventive and/or curative treatment of crop diseases.

11. A phytosanitary formulation comprising:
a hydrocarbon fluid comprising at least 80% by weight of isoparaffins and less than 100 ppm by weight of aromatics, relative to the total weight of the hydrocarbon fluid, said hydrocarbon fluid having a biodegradability of at least 60% at 28 days, measured according to the OECD 301B standard and said fluid having an initial boiling point and a final boiling point ranging from 260 to 320 °C, and
one or more surfactants,
characterized in that:
a) the formulation further comprises an active ingredient chosen from herbicides, insecticides, acaricides, fungicides, and biostimulants, and/or
b) the weight ratio between the hydrocarbon fluid and the surfactants ranges from 18 to 40.

12. The phytosanitary formulation according to claim 11, wherein the hydrocarbon fluid comprises relative to the total weight of the hydrocarbon fluid:
at least 85% by weight of isoparaffins, preferably at least 90% by weight, more preferably at least 95% by weight, and/or
at most 20% by weight of normal paraffins, preferably at most 10% by weight, more preferably at most 5% by weight, and/or
at most 1% by weight of naphthenes, and/or
less than 50 ppm by weight of aromatics.

13. The phytosanitary formulation according to claim 11, in the form of an emulsifiable concentrate comprising, preferably consisting of:
from 95 to 97% by weight of hydrocarbon fluid,
from 3 to 5% by weight, of one or more surfactants,
relative to the total weight of the phytosanitary formulation.

14. The phytosanitary formulation according to claim 11, comprising at least one surfactant chosen from alkoxylated acids and alkoxylated alcohols and mixtures thereof, and optionally further comprising at least one surfactant chosen from sorbitan esters.

15. A method of phytosanitary treatment of crops comprising the application of the phytosanitary formulation according to claim 11, the application being preferably implemented by spraying on the crops, e.g. by spraying or spreading, in particular using a drone.

16. The phytosanitary formulation according to claim 11, wherein the surfactant(s) are chosen from alkoxylated acids, sorbitan esters, alkoxylated alcohols, and mixtures thereof.

17. The phytosanitary formulation according to claim 11, wherein the phytosanitary formulation comprises:
from 0.5 to 20% by weight, preferably from 1 to 15% by weight, more preferably from 2 to 10% by weight, of one or more surfactants,
from 80 to 99.5% by weight, preferably from 85 to 99% by weight, more preferably from 90 to 98% by weight, of hydrocarbon fluid,
relative to the total dry weight of the phytosanitary formulation.
